(19) United States
(12) Patent Application Publication
(10) Pub. No.: US 2009/0314757 A1
(43) Pub. Date: Dec. 24, 2009

(54) Thick gage welding

(75) Inventor: Alexei P. Yelistratov, Dunlap, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/141,691

(22) Filed: Jun. 18, 2008

(51) Int. Cl. B23K 9/00; B32B 15/00

(52) U.S. Cl. 219/137 R; 428/615

(57) ABSTRACT

A method of thick gage welding joins a first work piece to a second work piece. Abutting edges of the pieces are parallel and separated by a gap G. A displacer is inserted between the work pieces with its bottom surface substantially flush with undersides of the work pieces. The displacer width w is from 0.5G to 0.7G and the displacer height h is about 1.5 times the weld penetration depth. Respective root passes are executed with average current along the bottom of the displacer at the edge of the first work piece and the second work piece. Subsequently, respective root passes are executed at full current, or higher than average current, along the top of the displacer at the edge of the first work piece and the second work piece. The remaining space is filled via additional welding pass(es) to create a completed weld.

### TECHNICAL FIELD

This disclosure relates generally to systems and methods for welding metallic pieces together and, more particularly, to a system and method for welding large gage metallic pieces without extensive beveling of the surfaces to be joined.

### BACKGROUND

In the most general terms, a welding process is a process that joins two pieces of similar material via a molten, or otherwise thinned or liquefied, portion of the same type of material. The molten portion may derive from a third piece of material, i.e., a “filler” piece, or may run off of one or both of the primary pieces. Ideally, the material being welded will be at least as strong at the seam as the original material pieces. Although in general welding may be performed on nonmetallic materials, e.g., the welding of plastics via solvents, the terms “weld,” “welding” and related terms used herein will refer specifically to the joining of two or more metallic pieces of material via molten metallic material.

The quality of a welded joint directly affects the strength and fatigue resistance of the joint. Welded joints and the associated metal parts are often subjected to discrete severe stressor events as well as cyclic or periodic events of lower stress. The applied stresses may be tensile, torsional, or otherwise, and may vary in strength and character throughout the weld joint. The results of a failed weld are often costly and may also be dangerous. Thus, it is important in most applications and environments where welding is used to create a strong, high quality weld.

Typically, a weld bead is applied along the abutting surfaces of the work pieces during the welding process. The abutting surfaces thus form a weld seam or weld joint between the work pieces. This weld bead is received within the seam and extends along the length of seam. If the configuration of the weld bead is poor, the life of the welded joint will be short. For example, if the weld includes a sharp notch between the weld bead and the work piece, the joint will usually have a short fatigue life. Moreover, if the joint between pieces to be welded is not completely filled and the abutting surfaces completely joined, the weld may be weaker than surrounding material and may thus experience stress risers leading to premature failure. Moreover, the incompletely welded abutting surfaces may be susceptible to increased corrosion and wear.

When welding thin materials, the joint easily fills with molten material via capillary or gravitational action. However, for thicker gage materials, especially, though not exclusively, those where the depth of the weld joint substantially exceeds the width between abutting pieces, a weld between parallel abutting surfaces may not completely fill, leaving voids and breaks.

One technique that has evolved in the art to cure this deficiency entails beveling the abutting surfaces so as to vary the width of the joint. In this connection, see, for example, the discussion of pre-weld joint beveling in U.S. Pat. No. 4,728,126 to Sundholm. Through this beveling, the joint is widest at the top, allowing the joint to more easily fill. However, this technique requires extensive preparation work due to the beveling. Moreover, mistakes in the size of the gap between abutting surfaces are not easily corrected, and may require the preparation of a replacement piece.

While various embodiments described herein are directed at solving the aforementioned problems, it will be appreciated that the solution of these problems is not a requirement of any claim unless expressly noted therein. Moreover, while this background section is presented as a convenience to the reader, it will be appreciated that this section is too brief to attempt to accurately and completely survey the prior art. The preceding background description is thus a simplified and anecdotal narrative and is not intended to replace printed references in the art. To the extent an inconsistency or omission between the demonstrated state of the printed art and the foregoing narrative exists, the foregoing narrative is not intended to cure such inconsistency or omission. Rather, applicants would defer to the demonstrated state of the printed art.

### SUMMARY

In one aspect, an improved method is provided for welding thick gage metallic materials together. In an embodiment of the disclosed principles, a first edge associated with a first thick gage work piece is welded to a second edge associated with a second thick gage work piece. Unlike prior systems, the surface of the first edge is parallel to the surface of the second edge, and the first edge and the second edge are separated by a gap G. A displacer is inserted between the pieces so that the displacer has a bottom surface substantially flush with respective undersides of the first thick gage work piece and the second thick gage work piece. In an embodiment, the displacer has a width w of about 0.5G and about 0.7G and a height h of about 1.5 times the penetration depth for a gap that is from about 0.15G to about 0.25G. From this starting configuration, root passes are executed along a joint between the bottom of the displacer and the first thick gage work piece and along a joint between the bottom of the displacer and the second thick gage work piece. After this, root passes are executed along a joint between the top of the displacer and the first thick gage work piece and along a joint between the top of the displacer and the second thick gage work piece. The remaining space between the surface of the first edge and the surface of the second edge are filled via at least one additional welding pass to create a completed weld.

In another aspect, a three piece weld joint is provided joining a first work piece to a second work piece. The three piece weld joint includes in an embodiment a surface of the first work piece, a surface of the second work piece, wherein the surface of the second work piece is substantially parallel to the surface of a first work piece, and a displacer within the three piece weld joint. The displacer has a height that is less than the thickness of the work pieces and has a first surface that is parallel to the surface of the first work piece and a second surface that is parallel to the surface of the second work piece.

### BRIEF DESCRIPTION OF THE DRAWINGS

FIG. 1 is a series of cross-sectional side views of thin and thick gage welds not in accordance with accordance with the disclosed principles;

FIG. 2 is a cross-sectional side view of a pre-weld thick gage structure in accordance with the disclosed principles;

FIG. 3 is a cross-sectional side view of a post-weld thick gage structure in accordance with the disclosed principles;

FIG. 4 is a cross-sectional side view of the post-weld thick gage structure of FIG. 3, wherein further weld processing has been executed;

FIG. 5 shows a series of progressive cross-sectional side views of a thick gage weld being formed in accordance with the disclosed principles; and

FIG. 6 is a flow chart illustrating a process of creating a thick gage weld in accordance with the disclosed principles.

### DETAILED DESCRIPTION

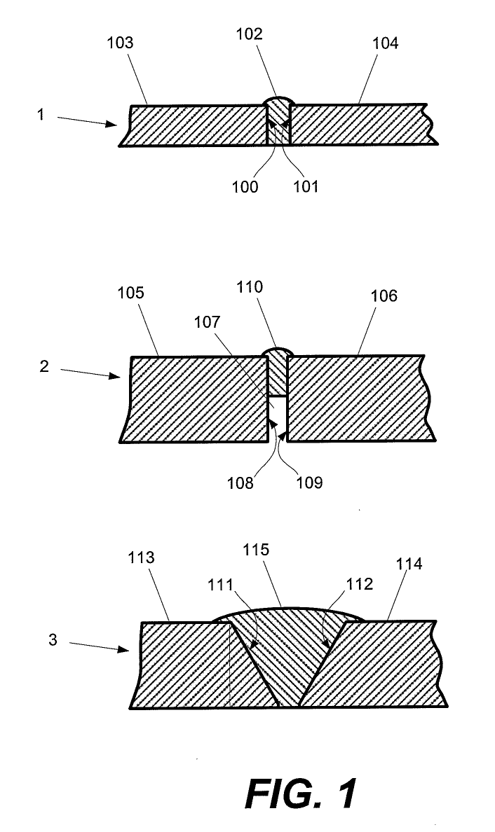

Before describing the disclosed implementations in detail, a brief description of the standard thin gage and beveled thick gage welding process will be undertaken to aid the reader. FIG. 1 shows several cross-sectional views, including a cross-sectional side view of a standard thin gage weld 1. The abutting surfaces 100, 101, are parallel, and the bead 102 fully penetrates the gap between the first work piece 103 and the second work piece 104. This presents a suitable weld geometry. FIG. 1 also illustrates a second cross-sectional view of an unsuitable thick gage weld 2. Here, the thickness of the first work piece 105 and the second work piece 106 are such that with essentially the same gap distance as the first weld, the second weld is incomplete, leaving a void 107 between the abutting surfaces 108, 109. The bead 110 has only penetrated approximately half of the joint.

As used herein, the term “thick gage” refers to pieces having a thickness of about 0.5 inches or greater. Different welding techniques are required for thick gage welding because a thin gage weld structure does not simply scale up to a thick gage weld. That is, one cannot successfully weld a thick material by simply proportionally increasing the gap size. In large part, this is because the qualities of molten metal do not scale upward, much the same way that the failure of gas dynamics to scale proportionally results in the use of a Reynolds number when scaling aerodynamic structures.

The final cross-sectional view in FIG. 1 is a cross-sectional view of a weld 3 according to a known method of thick gage welding, wherein abutting surfaces 111, 112 of the first work piece 113 and the second work piece 114 respectively have been beveled. This allows the bead 115 to penetrate the full depth of the joint. However, as noted above, the process of beveling must be executed carefully, and is time-consuming and error prone.

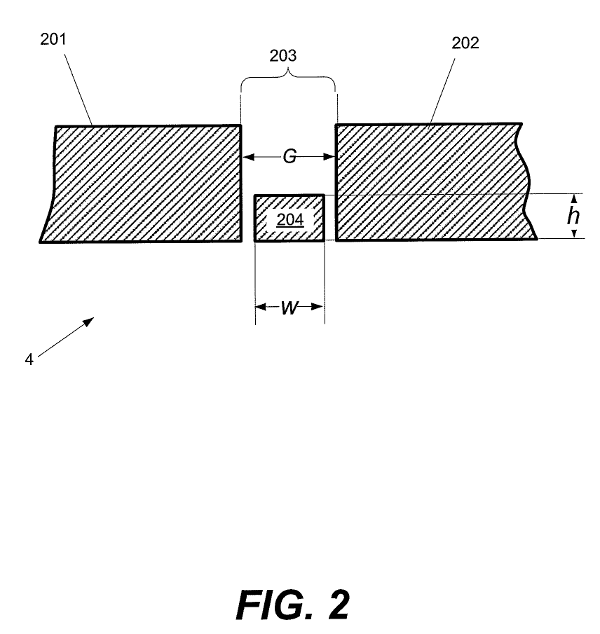

Turning to the specifics of the described embodiments, FIG. 2 shows a cross-sectional side view of a thick gage joint 4 awaiting welding. The thickness of the first work piece 201 and the second work piece 202 are such that beveling as described above would ordinarily be required in order to produce a quality weld joint. However, the use of beveling introduces uneven residual stresses into the finished weld. In addition, the use of beveling creates thin lower surfaces within the weld channel, requiring the use of low welding current for the root pass as the joint is filled. This results in delay and may also cause incomplete bonding of the weld to the material walls.

In an embodiment, these drawbacks are alleviated in large part by structuring the pre-weld joint to include a parallel gap 203 of width G and a displacer 204. The width w of the displacer 204 is configured to be about 0.5G-0.7G and the height h of the displacer 204 is configured to be about 1.5 times the penetration expected on a gap that is from about 0.15G to about 0.25G. In addition to this specialized configuration, a prescribed process is used in an embodiment to ensure that the joint is securely welded.

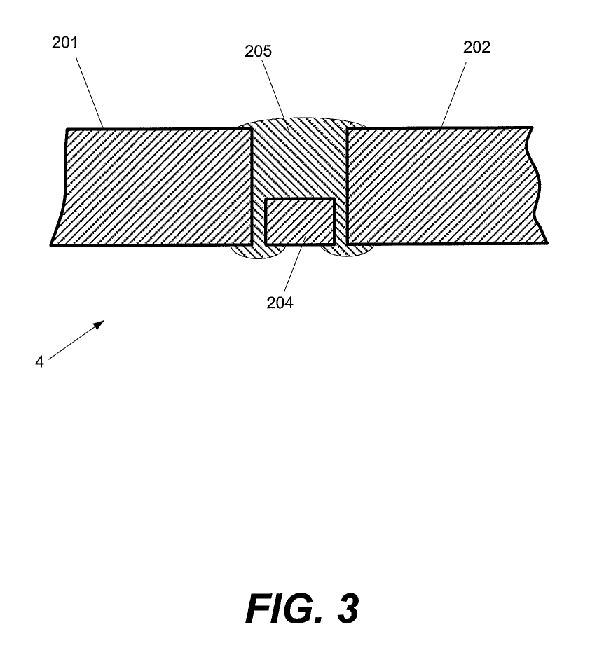

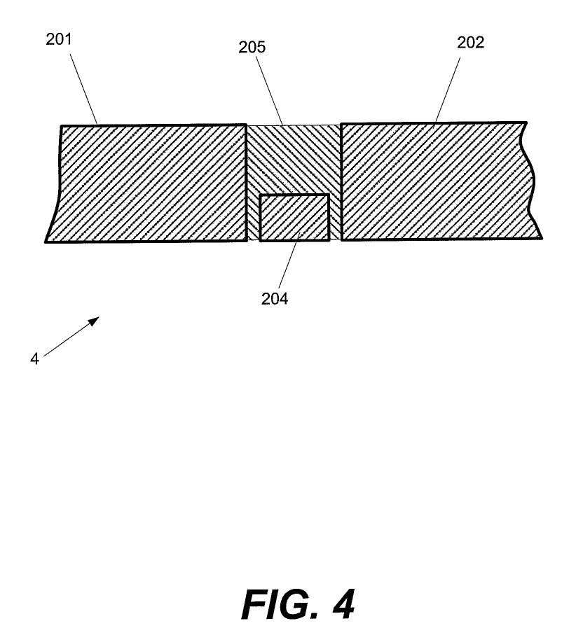

FIG. 3 shows a shows a cross-sectional side view of the thick gage joint 4 after welding. As can be seen, the weld bead 205 (referred to in the singular although it will be appreciated from the description hereinafter that the weld bead 205 may be constructed via several welding passes) fills the various gaps between the first work piece 201, the second work piece 202, and the displacer 204. In the illustrated state, the weld bead 205 also extends above the top surfaces of the first work piece 201 and the second work piece 202 and below the bottom surfaces of the first work piece 201 and the second work piece 202. After the joint 4 has solidified sufficiently, it may be ground or machined into conformance with the surrounding structures as shown in FIG. 4 if desired.

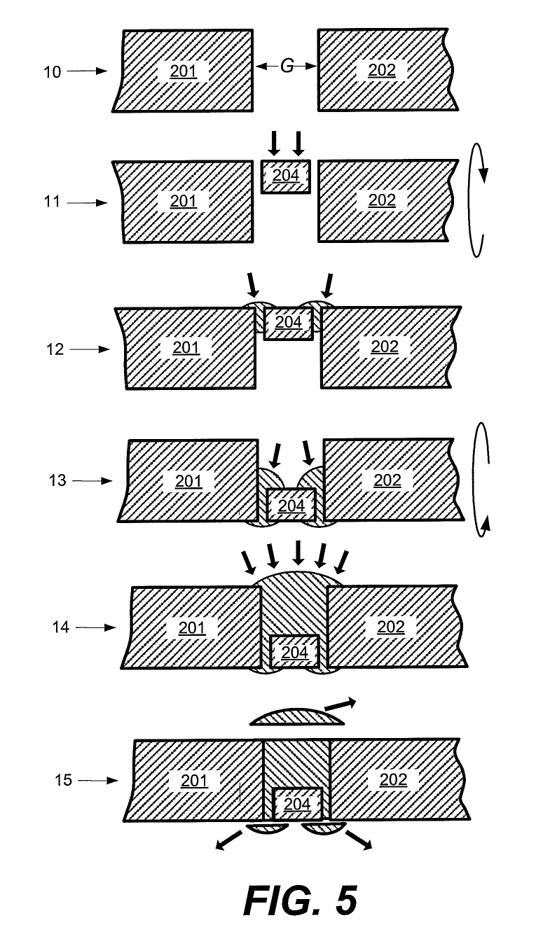

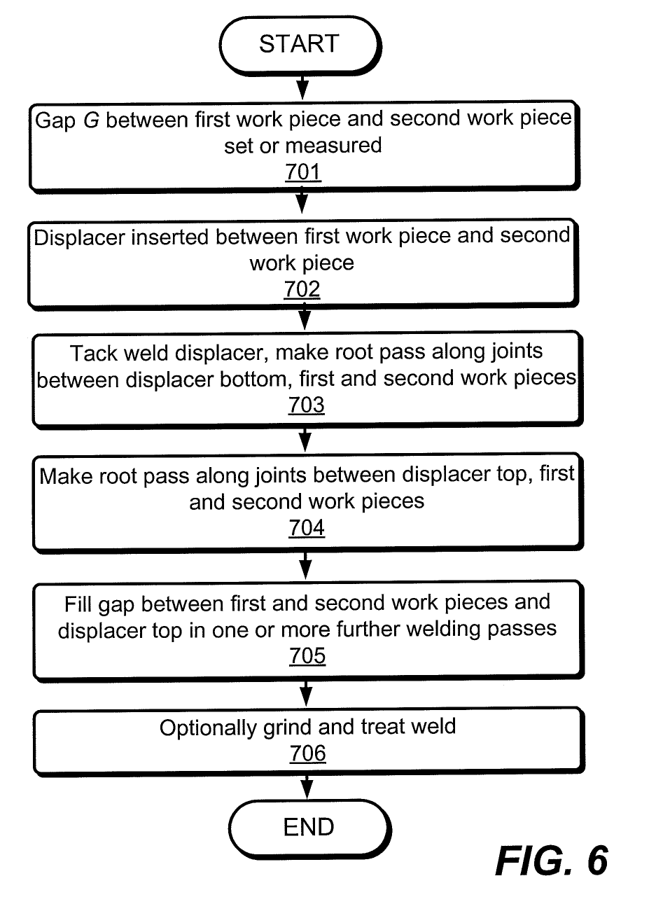

The specialized process for creating the weld joint 4 as shown in FIGS. 3 and 4 is illustrated in the series of cross-sectional views in FIG. 5, in conjunction with the flow chart of FIG. 6. Referring now to the process 700 for forming a thick gage weld illustrated via the flowchart of FIG. 6, and the structural stages shown in FIG. 5, the thick gage pieces to be welded, e.g., first work piece 201 and the second work piece 202, are prepared with a gap G at stage 701, as shown structurally at structural stage 10 of FIG. 5. Alternatively, the placement of the first work piece 201 and the second work piece 202 may be fixed, and the gap G may then be ascertained via measurement. When a series of similar welds are being prepared, a single measurement or setup may be made with respect to a first set of work pieces, after which future sets of work pieces are jigged or tabbed in place without further measurement.

At stage 702, a suitable displacer 204 is inserted between the first work piece 201 and the second work piece 202. In the configuration illustrated at structural stage 11 of FIG. 5, the first work piece 201 and the second work piece 202 are inverted and the displacer 204 is inserted into the underside of the gap G, until is substantially centered in the gap G from left to right and flush with the underside of the first work piece 201 and the second work piece 202.

It will be appreciated that displacer 204 need not precisely flush, but may be only substantially flush, and may not be precisely centered but may be only substantially centered, with the degree of precision depending largely on the skill of the operator as well as the facilities and materials employed in the process 700. The size of the displacer 204 is within the dimensions given above in an embodiment. In particular, the width w of the displacer 204 is configured to be between 0.5G-0.7G and the height h of the displacer 204 is configured to be 1.5 times the penetration expected on a gap that is from 0.15G to 0.25G.

Once the displacer 204 is properly dimensioned and placed as described in stage 702 of the process 700, the displacer 204 is tack welded to the first work piece 201 and the second work piece 202, and a root pass made along both joints between the displacer 204 and the first work piece 201 and the second work piece 202, respectively, at stage 703 of the process 700. This step is illustrated structurally in structural stage 12 of FIG. 5. It will be appreciate that the tack weld that begins stage 703 of the process 700 is not explicitly shown, and indeed, other means of holding the displacer 204 in position during the first two root passes may instead be used.

With the displacer 204 now welded in place via the two root welds on the underside, the work may be handled but the joint does not yet have full strength. However, at stage 704 of the process 700, as illustrated at structural stage 13 of FIG. 5, a root pass is made along both joints between the top of the displacer 204 and the first work piece 201 and the second work piece 202, respectively. In this description, the “top” of the displacer 204 is the surface of the displacer 204 that lies furthest within the gap G between the first work piece 201 and the second work piece 202. With the height of the displacer 204 at about 1.5 times the expected penetration in a gap of from 0.15G to 0.25G, and the width w selected as described above, the abutting surfaces of the displacer 204 are fully welded to the first work piece 201 and the second work piece 202, respectively, with no void or space in the weld.

At this point, the space remaining in the gap G between the first work piece 201 and the second work piece 202 is filled by one or more further welding passes at stage 705 of process 700, as shown in structural stage 14 of FIG. 5. After this stage, the weld may bulge outward beyond both the top and bottom surfaces of the first work piece 201 and the second work piece 202. The weld is usable at this point, but may be refined at stage 706 of process 700 to eliminate stress concentrations and/or improve the aesthetic presentation of the weld. In particular, at this stage, excess material is ground or machined away from the joint to leave the weld flush with the top and bottom surfaces of the first work piece 201 and the second work piece 202. This step is shown structurally in structural stage 15 of FIG. 5.

The finished weld may be thermally tempered or stress relived in any suitable manner if desired, and in an embodiment, the finished joint is coated or otherwise processed for corrosion resistance and appearance as needed.

### INDUSTRIAL APPLICABILITY

The present disclosure is applicable to welding metallic structures of thick gage materials and provides an improved system wherein thick gage structures are welded together via a displacer 204 that serves to improve the weld characteristics. This process eliminates the need to bevel the work pieces while providing a stronger joint with no voids and with improved strength and fatigue resistance characteristics.

In an embodiment of the new process, a gap G between pieces of thick gage steel (e.g., thicker than about 0.5 inches) is created with a displacer 204, having a width w of about 0.5-0.7G and height h of about 1.5 of the weld's penetration depth, installed inside the gap. The displacer 204 is made flush to the bottom surface of the joint, and is tack welded to both parts of the joint from the underside. The joints are then welded with full strength root passes at each corner of the displacer 204, followed by one or more filling welds within the remaining gap. When employing arc weld technology, the welds at the bottom corners of the displacer 204 are made with average welding current to provide penetration of 0.5-0.7 of the bar's height, and the root welds at the top of the displacer 204 are made with high welding current.

The process allows the use of high welding currents, which makes the root welds of higher quality than they would be using the traditional bevel technique. In addition, executing the weld without beveling the adjoining surfaces creates a much more uniform pattern of residual stresses in the welded structure, improving weld quality and fatigue performance. This is because a weld with parallel walls generates more uniform residual stress patterns in the welded structure. The disclosed technique also serves to eliminate a machining/processing step, e.g., the beveling of abutting surfaces. With the disclosed technique, there is no need for additional specialized equipment, since the displacer 204 can in most cases be made from available steel stock without special requirements for its machining.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of welding a first edge associated with a first thick gage work piece to a second edge associated with a second thick gage work piece, wherein a surface of the first edge is parallel to a surface of the second edge, and wherein the first edge and the second edge are separated by a gap G, the method comprising:
inserting a displacer between the first thick gage work piece and the second thick gage work piece so that the displacer has a bottom surface substantially flush with respective undersides of the first thick gage work piece and the second thick gage work piece and is substantially centered between the first and second work pieces, a width w of the displacer being between about 0.5G and about 0.7G and a height h of the displacer being about 1.5 times a penetration for a gap that is from about 0.15G to about 0.25G;
executing a root welding pass along a joint between the bottom of the displacer and the first thick gage work piece and executing a root welding pass along a joint between the bottom of the displacer and the second thick gage work piece;
executing a root welding pass along a joint between the top of the displacer and the first thick gage work piece and executing a root welding pass along a joint between the top of the displacer and the second thick gage work piece; and
filling a remaining space between the surface of the first edge and the surface of the second edge via at least one additional welding pass to create a completed weld.

2. The method of welding according to claim 1, further comprising refining the completed weld to eliminate stress concentrations and/or improve the aesthetic presentation of the weld.

3. The method of welding according to claim 2, wherein refining the completed weld to eliminate stress concentrations and/or improve the aesthetic presentation of the weld includes removing excess material from the completed weld to leave the weld flush with the top and bottom surfaces of the first and second work pieces.

4. The method of welding according to claim 3, removing excess material from the completed weld comprises grinding the weld.

5. The method of welding according to claim 3, removing excess material from the completed weld comprises machining the weld.

6. The method of welding according to claim 1, wherein the displacer has a width of about 0.5G to about 0.7G.

7. The method of welding according to claim 1, further comprising ascertaining a dimension of the gap G prior to inserting the displacer.

8. The method of welding according to claim 1, further comprising jigging the first and second work pieces to establish the gap G.

9. The method of welding according to claim 1, further comprising tack welding the displacer to the first thick gage work piece and the second thick gage work piece.

10. The method of welding according to claim 1, wherein each root welding pass has a penetration depth that is less than the height h of the displacer.

11. A three piece weld joint joining a first work piece to a second work piece, the three piece weld joint comprising:
a surface of the first work piece;
a surface of the second work piece, wherein the surface of the second work piece is substantially parallel to the surface of a first work piece; and
a displacer within the three piece weld joint, the displacer having a first surface that is parallel to the surface of the first work piece and a second surface that is parallel to the surface of the second work piece.

12. The three piece weld joint according to claim 11, wherein the displacer has a bottom surface substantially flush with respective undersides of the first and second work pieces.

13. The three piece weld joint according to claim 11, wherein the displacer is substantially centered between the first and second work pieces.

14. The three piece weld joint according to claim 11, wherein the first and second work pieces are separated by a gap G, and the displacer has a width w that is between about 0.5G and about 0.7G and a height h that about 1.5 times a weld penetration value for a gap that is from about 0.15G to about 0.25G.

15. A method of welding a first thick gage work piece to a second thick gage work piece via respective abutting surfaces of the first and second work pieces, wherein the abutting surfaces of the first and second work pieces have a thickness dimension, the method comprising:
configuring a pre-weld joint including the abutting surfaces of the first and second work pieces and a displacer disposed between the abutting surfaces of the first and second work pieces, such that the abutting surfaces of the first and second work pieces are parallel in the thickness dimension and are separated by a gap G, the displacer extending within the gap for between about 0.5G and about 0.7G and having a bottom surface substantially flush with respective undersides of the first and second work pieces and being substantially centered between the first and second work pieces;
executing a first root welding pass along a first opening between the bottom of the displacer and the first thick gage work piece and executing a second root welding pass along a second opening between the bottom of the displacer and the second thick gage work piece, such that the first root welding pass and the second root welding pass create respective first and second beads that do not extend to the top of the displacer;
executing a third root welding pass along an opening between the top of the displacer and the first thick gage work piece and executing a fourth root welding pass along an opening between the top of the displacer and the second thick gage work piece to create third and fourth beads, respectively, wherein the third bead joins the first bead and the fourth bead joins the second bead; and
executing one or more additional welding passes to fill any remaining space between the abutting surfaces of the first and second work pieces to create a completed weld.

16. The method of welding according to claim 15, further comprising refining the completed weld to eliminate stress concentrations and/or improve the aesthetic presentation of the weld.

17. The method of welding according to claim 16, wherein refining the completed weld to eliminate stress concentrations and/or improve the aesthetic presentation of the weld includes removing excess material from the completed weld to leave the weld flush with the top and bottom surfaces of the first and second work pieces.

18. The method of welding according to claim 16, wherein removing excess material from the completed weld includes at least one of grinding and machining the excess material.

19. The method of welding according to claim 15, further comprising jigging the first and second work pieces to establish the gap G.

20. The method of welding according to claim 15, further comprising tack welding the displacer to the first thick gage work piece and the second thick gage work piece.
